(19) United States
(12) Patent Application Publication
(10) Pub. No.: US 2008/0073615 A1
(43) Pub. Date: Mar. 27, 2008

(54) Method for producing resorcin/formaldehyde resin

(75) Inventor: Tatsumi Nuno, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/826,243

(22) Filed: Jul. 13, 2007

(30) Foreign Application Priority Data
Jul. 24, 2006 (JP) 2006-200370
Sep. 29, 2006 (JP) 2006-267184
Oct. 26, 2006 (JP) 2006-290991

(51) Int. Cl. C09K 3/00

(52) U.S. Cl. 252/182.12

(57) ABSTRACT

A method for producing a resorcin/formaldehyde resin comprising subjecting a salts-containing aqueous solution, resorcin, formaldehydes and aliphatic ketone having 3 to 6 carbon atoms to a polymerization reaction in the presence of an acidic catalyst, separating the reaction liquid after reaction between an aqueous phase and an organic phase, and obtaining a resorcin/formaldehyde resin from the organic phase, wherein the aqueous phase recovered by separating is distilled to adjust the aliphatic ketone content to 0.3 wt % or less and the alcohol content to 0.1 wt % or less, and the aqueous phase having a salts concentration adjusted to 35 to 45 wt % is used as said salts-containing aqueous solution.

### TECHNICAL FIELD OF THE INVENTION

The present invention relates to a method for producing a resorcin/formaldehyde resin in the presence of an aliphatic ketone such as methyl ethyl ketone and the like.

### BACKGROUND OF THE INVENTION

Resorcin/formaldehyde resins are obtained by polymerizing resorcin and formaldehydes in an aqueous solution in the presence of an acidic catalyst, and for example, used widely as adhesives for woods and tires. Resorcin/formaldehyde resins of high molecular weight, however, have a problem of lowering flowability to cause difficulty in handling as an adhesive, while if the molar ratio of resorcin to formaldehyde is increased to attain lower molecular weight, the content of unreacted resorcin increases, thereby causing a problem that resorcin vaporizes in a thermal processing operation in adhering to give difficulty in handling as an adhesive.

As a solution for such a problem, Patent Document 1 discloses a method in which the above-mentioned polymerization reaction is performed in one step reaction operation, by using salts such as calcium chloride and the like as a molecular weight modifier, to obtain a resorcin/formaldehyde resin of low molecular weight having small resorcin content and excellent in flowability.

For the same purpose, Patent Document 2 discloses a fact that the above-described polymerization reaction is performed in one step reaction of a two phase system, in the presence of a ketone of low molecular weight such as methyl ethyl ketone and the like in an amount of 1 to 0.5 parts by weight based on 1 part by weight of resorcin, to obtain a ketone-modified resorcin/formaldehyde resin in which both the content of a resorcin monomer and the content of a resorcin/formaldehyde resin containing 5 or more resorcin cores are lowered.

However, it has turned out that, in the above-described method, an aqueous phase remaining after a process of acquiring an organic phase containing a resorcin/formaldehyde resin by separation as a post treatment process after polymerization reaction contains the above-described salts in relatively large amount, thus, re-use thereof is required, and if this is used itself as salts in the polymerization reaction, the resulting resorcin/formaldehyde resin gets high molecular weight, thereby causing increase in viscosity, to provide difficulty in handling as an adhesive.
[Patent Document 1] JP-A No. 2003-277308
[Patent Document 2] JP-A No. 2005-133085

### DISCLOSURE OF THE INVENTION

The object of the present invention is to provide a method for producing a resorcin/formaldehyde resin, the method providing a resorcin/formaldehyde resin excellent in flowability and having small resorcin content even if recycle salts are used.

That is, the present invention provides the following [1] to [10].
[1]. A method for producing a resorcin/formaldehyde resin comprising subjecting a salts-containing aqueous solution, resorcin, formaldehydes and aliphatic ketone having 3 to 6 carbon atoms to a polymerization reaction in the presence of an acidic catalyst, separating the reaction liquid after reaction between an aqueous phase and an organic phase, and obtaining a resorcin/formaldehyde resin from the organic phase, wherein the aqueous phase recovered by separating is distilled to adjust the aliphatic ketone content to 0.3 wt % or less and the alcohol content to 0.1 wt % or less, and the aqueous phase having a salts concentration adjusted to 35 to 45 wt % is used as said salts-containing aqueous solution.
[2]. The production method according to [1], wherein the polymerization reaction includes the following processes [A] and [B]:

[A] a process of adding formaldehydes to mixed liquid containing a salts-containing aqueous solution, resorcin and acidic catalyst and preliminarily polymerizing them to obtain a preliminarily polymerized liquid;

[B] a process of adding an aliphatic ketone having 3 to 6 carbon atoms and formaldehydes to the preliminarily polymerized liquid obtained in the process [A] and main-polymerizing them to obtain polymerized liquid. [3]. A method for producing a resorcin/formaldehyde resin comprising adding formaldehydes to mixed liquid containing a salts-containing aqueous solution, resorcin and acidic catalyst and preliminarily polymerizing them to obtain a preliminarily polymerized liquid, adding an aliphatic ketone having 3 to 6 carbon atoms and formaldehydes to the resultant preliminarily polymerized liquid and main-polymerizing them to obtain polymerized liquid.
[4]. The production method according to [2] or [3] wherein the amount of the formaldehydes to be used for the preliminarily polymerization is 0.01 to 0.7 mol per mol of resorcin, and the total amount of the formaldehydes is 0.3 to 1 mol per mol of resorcin.
[5]. The production method according to any one of [1] to [4] wherein the salt is calcium chloride.
[6]. The production method according to any one of [2] to [5] wherein the reaction time of the preliminarily polymerization is 10 minutes to 2 hours.
[7]. The production method according to any one of [2] to [6] wherein the aliphatic ketone and formaldehydes are mixed intermittently or continuously with the preliminarily polymerized liquid over a period of 1 to 5 hours.
[8]. The production method according to any one of [2] to [7] wherein the aliphatic ketone is mixed with the preliminarily polymerized liquid over a period of 30 minutes, and the aliphatic ketone is mixed before completion of mixing of all the formaldehydes.
[9]. The production method according to any one of [2] to [8] wherein the amount of the aliphatic ketone to be mixed with the preliminarily polymerized liquid is 0.8 to 6 mol per mol of the total amount of the formaldehydes.
[10]. The production method according to any one of [2] to [9] wherein the polymerized liquid after completion of the main polymerization is neutralized, separated, and the resulting organic phase is azeotropically dehydrated, then, ammonia is mixed with this.

### BRIEF EXPLANATION OF DRAWINGS

FIG. 1 is a liquid chromatogram of a resorcin/formaldehyde resin obtained in Example 3.

FIG. 2 shows ¹H-NMR of compound (1) (component corresponding to elution time 20.1 minutes in FIG. 1).

FIG. 3 shows ¹H-NMR of compound (2) (component corresponding to elution time 25.8 minutes in FIG. 1).

### MODE FOR CARRYING OUT THE INVENTION

The present invention will be described in detail below.

The present invention is a method of subjecting a salts-containing aqueous solution, resorcin, formaldehydes and aliphatic ketone having 3 to 6 carbon atoms to a polymerization reaction in the presence of an acidic catalyst, separating the reaction liquid after reaction between an aqueous phase and an organic phase, and obtaining a resorcin/formaldehyde resin from the organic phase, and characterized in that the aqueous phase recovered by separating is distilled to adjust the aliphatic ketone content of 0.3 wt % or less and the alcohol content of 0.1 wt % or less, thereby, the aqueous phase having a salts concentration adjusted to 35 to 45 wt % is used as the above-described salts-containing aqueous solution.

Salts contained in the salts-containing aqueous solution include sodium salts such as sodium citrate, sodium tartarate, sodium acetate, sodium sulfate, sodium chloride and the like, calcium salts such as calcium citrate, calcium tartarate, calcium chloride and the like, and magnesium salts such as magnesium chloride and the like. Among these salts, calcium chloride and sodium sulfate are preferable, and calcium chloride is particularly preferable.

The use amount of the salts in the polymerization reaction is usually in the range of 0.2 to 20 mol per mol of resorcin, preferably in the range of 0.5 to 10 mol per mol of resorcin.

The concentration of the salts in the salts-containing aqueous solution in the polymerization reaction is 35 to 45 wt %, preferably 37 to 43 wt %. When the concentration of the salts is 35 wt % or more, there are a preferable tendency of increase of the reaction speed of the polymerization reaction when a salts-containing aqueous solution is re-used, and a preferable tendency of improvement in liquid separating property in separating after the polymerization reaction when a salts-containing aqueous solution is re-used, while when 45 wt % or less, there is a preferable tendency of decrease in deposition of salts in the polymerization reaction when a salts-containing aqueous solution is re-used.

The use amount of water in the polymerization reaction is usually in the range of 50 to 6000 parts by weight, preferably in the range of 50 to 2000 parts by weight, more preferably in the range of 50 to 1000 parts by weight based on 100 parts by weight of the total amount of resorcin and formaldehydes. When an aqueous solution such as formalin is used as formaldehydes, also water contained in the aqueous solution is included in the above-described use amount.

Examples of the acidic catalyst in the polymerization reaction include inorganic acids such as hydrochloric acid, sulfuric acid, nitric acid, phosphoric acid and the like, heteropoly acids such as phosphotungstic acid, phosphomolybdic acid and the like, metal halides such as zinc chloride, aluminum chloride and the like, organic carboxylic acids such as trichloroacetic acid, acetic acid, oxalic acid and the like, organic sulfonic acids such as methanesulfonic acid, ethanesulfonic acid, p-toluenesulfonic acid, phenolsulfonic acid and the like. These acidic catalysts may be used singly or in admixture of two or more.

The acidic catalyst includes preferably hydrochloric acid and p-toluenesulfonic acid, particularly preferably hydrochloric acid.

The use amount of the acidic catalyst is usually in the range of 0.0001 mmol to 5 mol, preferably in the range of 0.01 mmol to 2 mol, further preferably in the range of 1 mmol to 1 mol, per mol of resorcin.

Also in the case of re-use of a salts-containing aqueous solution obtained by the production method of the present invention, the kind and amount of the acidic catalyst are usually as described above in a similar fashion to the case of newly using an aqueous solution of salts and water.

The production method of the present invention comprises subjecting a salts-containing aqueous solution, resorcin, formaldehydes and aliphatic ketone to a polymerization reaction in the presence of an acidic catalyst, and the polymerization reaction is preferably a two-step polymerization method including the following processes [A] and [B]:

[A] a process of adding formaldehydes to mixed liquid containing a salts-containing aqueous solution, resorcin and acidic catalyst and preliminarily polymerizing them (wherein, the content of the aliphatic ketone having 3 to 6 carbon atoms in 100 parts by weight of the resultant preliminarily polymerized liquid is 1 part by weight or less);

[B] a process of adding an aliphatic ketone having 3 to 6 carbon atoms and formaldehydes to the preliminarily polymerized liquid obtained in the process [A] and main-polymerizing them.

In the process [A], a salts-containing aqueous solution (water and salts are used before re-use of the salts-containing aqueous solution), resorcin and acidic catalyst are mixed by stirring and the like, and usually dissolved uniformly. If necessary, they may be mixed by heating at 30 to 60° C.

In the mixed liquid, an organic solvent may be used for the purpose of dissolving the resulting resorcin/formaldehyde resin. The organic solvent means an organic compound excepting alcohols and ketone solvents, and specifically mentioned are lower fatty ester solvents such as ethyl acetate, butyl acetate and the like; ether solvents such as diethyl ether, diisopropyl ether, ethylene glycol dimethyl ether, tetrahydrofuran and the like; hydrocarbon solvents such as toluene, xylene, and the like. Among them, ethyl acetate and diisopropyl ether are preferable. The use amount of the organic solvent to be used is usually 1000 parts by weight or less, preferably 500 parts by weight or less based on 100 parts by weight of resorcin.

Subsequently, formaldehydes are added to mixed liquid of a salts-containing aqueous solution (water and salts), resorcin and acidic catalyst, and preliminary polymerization thereof is performed.

The preliminarily polymerization means adding only formaldehydes before addition of an aliphatic ketone having 3 to 6 carbon atoms (hereinafter, referred to as aliphatic ketone in some cases) and partially reacting resorcin and formaldehydes, and the reaction time of the preliminarily polymerization denotes a time period initiating from a point of adding formaldehydes to a point of adding an aliphatic ketone and formaldehydes. That is, the preliminary polymerization in the process [A] and the main polymerization in the process [B] are distinguished depending on substantial inclusion or substantial no inclusion of an aliphatic ketone. The substantial no inclusion means that the content of an aliphatic ketone in the reaction solvent is 0.3 wt % or less.

The formaldehydes used in the present invention include formaldehyde and formaldehyde precursors. Examples of the formaldehyde precursor include cyclic formals such as p-formaldehyde, trioxane and the like, chain-like formals such as methylal and the like. As the formaldehydes, formaldehyde is preferable.

The use amount of the formaldehydes used in the process [A] is usually 0.01 to 0.7 mol, preferably 0.05 to 0.4 mol in terms of formaldehyde per mol of resorcin.

The use amount of the formaldehydes used in the process [A] is usually 10 to 90 mol in terms of formaldehyde based on 100 mol of the total amount of the formaldehydes used in the present invention. Within the above-described parts by weight range, the resorcin content in the resulting resorcin/formaldehyde resin is lowered, and additionally, there is a preferable tendency of lowering of the viscosity of the resin.

The reaction temperature of the preliminarily polymerization is about 40 to 80° C., preferably about 50 to 70° C. When the temperature is 40° C. or higher, there is a preferable tendency of decrease in the resorcin content in the resultant resorcin/formaldehyde resin, and when 80° C. or lower, there is a preferable tendency of lowering of the viscosity of the resultant resorcin/formaldehyde resin.

In the preliminarily polymerization in the process [A], after adding formaldehydes, the reaction of resorcin and formaldehydes may be progressed while thermally insulating at the above-described reaction temperature, and for shortening the reaction time, the reaction time for thermal insulation is usually not necessary during the preliminarily polymerizing. That is, the reaction time of the preliminarily polymerization usually coincides with the mixing time of formaldehydes.

The reaction time of the preliminarily polymerization including the above-described thermal insulation time is usually about 10 minutes to 2 hours, preferably about 30 minutes to 1 hour. When the preliminarily polymerization time is 10 minutes or longer, there is a preferable tendency of decrease in the resorcin content in the resultant resorcin/formaldehyde resin, and when 2 hours or shorter, there is a preferable tendency of lowering of the viscosity of the resultant resorcin/formaldehyde resin.

In the process [A], the content of an aliphatic ketone having 3 to 6 carbon atoms in 100 parts by weight of the preliminarily polymerized liquid is preferably 1 part by weight or less, and it is more preferable that an aliphatic ketone having 3 to 6 carbon atoms is not substantially contained. When the content of the aliphatic ketone is 1 part by weigh or less, the viscosity of the resultant resorcin/formaldehyde resin is lowered. “Not substantially contained” means that the content of the aliphatic ketone in the reaction solution in the process [A] is 0.3 wt % or less.

Examples of the aliphatic ketone in the present invention include acetone, methyl ethyl ketone, methyl isobutyl ketone and the like, and methyl ethyl ketone is particularly preferable.

A process of adding an aliphatic ketone having 3 to 6 carbon atoms and formaldehydes to the preliminarily polymerized liquid obtained in the process [A] and performing main polymerization of them is the process [B].

The use amount of the aliphatic ketone in the process [B] is usually 0.8 to 6 mol per mol of the total amount of formaldehydes (in terms of formaldehyde) used in the production method of the present invention including the process [A], the process [B] and the like.

When the use amount of the aliphatic ketone is 6 mol or less, compounds of the following formulae (I) to (VI) are produced, and resultantly, there is a preferable tendency of improvement in adhesion performance in the resultant resorcin/formaldehyde resin. When 0.8 mol or more, the resorcin content in the resulting resorcin/formaldehyde resin is lowered, and additionally, there is a preferable tendency of lowering of the viscosity of the resin.

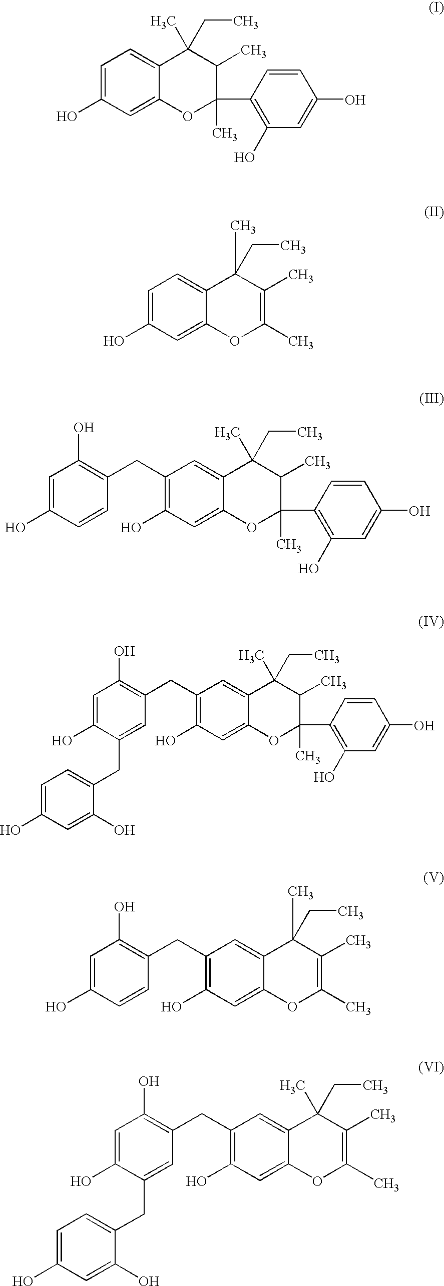

The use amount of formaldehydes used in the present invention (total amount of formaldehydes used in the production method of the present invention including the process [A], the process [B] and the like) is usually about 0.3 to 1 mol, preferably about 0.5 to 0.8 mol in terms of formaldehyde per mol of resorcin. Within the above-described range, the resorcin content in the resulting resorcin/formaldehyde resin is lowered, and additionally, there is a preferable tendency of lowering of the viscosity of the resin.

In the process [B], the aliphatic ketone and formaldehydes are usually mixed intermittently or continuously with the preliminarily polymerized liquid. By intermittent or continuous mixing, a reaction of polymerization to give a resorcin/formaldehyde resin also progresses simultaneously, and heat generation in this procedure can be controlled easily by the mixing speed of the aliphatic ketone and formaldehydes, thus, intermittent or continuous mixing is preferable.

The mixing temperature in the main polymerization in the process [B] is usually about 50 to 70° C., and preferably about 60 to 70° C. When the temperature is 50° C. or higher, there is a preferable tendency of decrease in the resorcin content in the resultant resorcin/formaldehyde resin, and when 70° C. or lower, there is a preferable tendency of lowering of the viscosity of the resultant resorcin/formaldehyde resin.

The mixing time of the main polymerization in the process [B] is usually about 1 to 5 hours, preferably about 1.5 to 3 hours. When the mixing time of the main polymerization is 1 hour or longer, there is a preferable tendency of decrease in the resorcin content in the resultant resorcin/formaldehyde resin, and when 5 hours or shorter, there is a preferable tendency of lowering of the viscosity of the resultant resorcin/formaldehyde resin.

The aliphatic ketone to be used in the process [B] is mixed usually over a period of 30 minutes or more. Preferably, the aliphatic ketone is mixed before mixing of all formaldehydes. When the aliphatic ketone is mixed within the above-mentioned range, there is a preferable tendency of lowering of the viscosity of the resultant resorcin/formaldehyde resin.

In the present invention, after completion of the polymerization reaction, an aqueous phase recovered by liquid separating is treated by the following process (2), and an aqueous solution having a salts concentration adjusted to 35 to 45 wt % by this treatment is re-used as the above-described salts-containing aqueous phase.

Process (2): a process of distilling an aqueous phase recovered by liquid separating to adjust the aliphatic ketone content to 0.3 wt % or less, and the alcohol content to 0.1 wt % or less.

The following process (1) may be carried out before the process (2), the process (1) and the process (2) may be carried out simultaneously, or they may be carried out in the order of process (2)→process (1), and usually, they are carried out in the order of process (1)→process (2), there occurs a preferable tendency of stopping the polymerization reaction of the resorcin/formaldehyde resin to lower the viscosity of the resorcin/formaldehyde resin.

Process (1): a process of mixing a base of alkali metal or alkaline earth metal constituting the salts with an aqueous phase recovered by liquid separating, to adjust pH to 4 to 8.

The method of carrying out the process (1) and the process (2) sequentially will be described in detail.

In the process (1), the reaction liquid after completion of the main polymerization is separated, and to the recovered aqueous phase is added a base of alkali metal or alkaline earth metal constituting the salts, to adjust pH of the aqueous phase to 4 to 8, alternatively, to the reaction liquid after completion of the main polymerization is added a base of alkali metal or alkaline earth metal constituting the salts, to adjust pH of the recovered aqueous phase to 4 to 8.

When the recovered aqueous phase has a pH of 4 or more, there are a preferable tendency of stabilization of the polymerization reaction speed when a salts-containing aqueous solution is re-used, to give an easy operation, and a preferable tendency of lowering of the viscosity of the resorcin/formaldehyde resin obtainable by re-use of a salts-containing aqueous solution.

When the recovered aqueous phase has a pH of 8 or less, there are a preferable tendency of increase in the polymerization reaction speed when a salts-containing aqueous solution is re-used, to give an easy operation, and a preferable tendency of lowering of the resorcin content in the resorcin/formaldehyde resin obtainable by re-use of a salts-containing aqueous solution.

The bases used to adjust pH include bases (for example, hydroxides, carbonates, bicarbonates and the like) of alkali metals or alkaline earth metals constituting salts to be used in the polymerization reaction when a salts-containing aqueous solution is re-used, and specific examples of hydroxides include sodium hydroxide which is a base in the case of the sodium salt, potassium hydroxide which is a base in the case of the potassium salt, lithium hydroxide which is a base in the case of the lithium salt, magnesium hydroxide which is a base in the case of the magnesium salt, and calcium hydroxide which is a base in the case of the calcium salt.

By use of a base of an alkali metal or alkaline earth metal constituting salts, one compound is used as the salts and regulation of the salts concentration becomes easy, thus, use of such a base is preferable.

Since preferable salts include calcium chloride, calcium hydroxide is a preferable base.

Subsequently, the process (2) is carried out. The aqueous phase having adjusted pH is distilled to adjust the aliphatic ketone content to 0.3 wt % or less and the alcohol content to 0.1 wt % or less. Specifically, water can be distilled off under reduced pressure or atmospheric pressure to reduce the aliphatic ketone and alcohol.

When the aliphatic ketone content is adjusted to 0.3 wt % or less and, thus, re-use of a salts-containing aqueous solution is performed, the viscosity in the resultant resorcin/formaldehyde resin can be decreased. When the alcohol content is adjusted to 0.1 wt % or less, the polymerization reaction speed in re-use as a salts-containing aqueous solution increases, to give easy operation.

When formalin to be used is in the form of industrial formalin aqueous solution, methyl alcohol is added as a stabilizer, thus, alcohol is mixed.

Into the recovered aqueous solution thus obtained, salts are added or water is added if necessary, to adjust the salts concentration to 35 to 45 wt %, preferably to 37 to 43 wt %. When the salts concentration in the aqueous solution is 35 wt % or more, there are a tendency of increase in the reaction speed of the polymerization reaction in re-use as a salts-containing aqueous solution and a tendency of improvement in liquid separating property in separating after the polymerization reaction in re-use as a salts-containing aqueous solution, while when 45 wt % or less, there is a tendency of reduction of deposition of a salt in the polymerization reaction in re-use as a salts-containing aqueous solution.

As the method for removing a resorcin/formaldehyde resin from the organic phase recovered after completion of the polymerization reaction, there are, for example, a method in which water is added if necessary, then, an organic phase is azeotropically distilled under reduced pressure or atmospheric pressure to distill off water and aliphatic ketone in the organic phase, and an alkali is added to the resultant remaining liquid to obtain a resorcin/formaldehyde resin in the form of aqueous solution, and other methods.

As the method for distilling off water and aliphatic ketone in the organic phase by azeotropic distillation, there are, for example, a method in which water is previously charged in a bath containing a resorcin/formaldehyde resin, then, water and aliphatic ketone are azeotropically distilled, a method in which water is added in small amount to a bath containing a resorcin/formaldehyde resin, then, water and aliphatic ketone are azeotropically distilled, and the azeotrope is if necessary cooled in this procedure to cause separating of water and aliphatic ketone, and only water is back-flown to the bath again, a method in which from a bath containing a resorcin/formaldehyde resin, water and aliphatic ketone are azeotropically distilled, and water in an amount corresponding to the distilled amount by azeotropic distillation is charged into the bath, and other methods.

Regarding the amounts of water and aliphatic ketone to be distilled off in azeotropic distillation, the aliphatic ketone is distilled off to an extent of substantially no inclusion and the resin is distilled off to an extent of scarce deposition, from the standpoint of preservation stability as the resorcin/formaldehyde resin aqueous solution, specifically, it is usually about 0.5 to 10-fold by weight based on the organic phase.

After completion of azeotropic distillation, a base is added in some cases for the purpose of improving dissolvability of the resultant resorcin/formaldehyde resin into water.

As the alkali to be used, an ammonia gas, ammonia aqueous solution and the like are used in addition to the above-mentioned bases used in stopping the polymerization reaction. Among them, when the amount of an alkali metal component left in the resorcin/formaldehyde resin is decreased, an ammonia gas or ammonia aqueous solution is preferable.

The temperature in adding this base is usually about 0 to 100° C., and preferably 20 to 80° C. from the standpoint of the viscosity and operability of the resorcin/formaldehyde resin.

The base addition amount is usually 0.01 to 200 mol, preferably 0.5 to 50 mol per mol of resorcin.

The resorcin/formaldehyde resin to be produced in the present invention may be dry solid or in the form of solution dissolved in a suitable solvent (for example, water and the like) manifesting convenient handling. Generally, a solution containing 10 to 70 wt % of a resorcin/formaldehyde resin manifests easy handling.

According to the present invention, salts may be re-used simply intact in the form of aqueous solution, and even if a polymerization reaction is carried out under the same reaction conditions, the resultant resorcin/formaldehyde resin has approximately equivalent qualities, namely, shows excellent flowability with low viscosity and has low resorcin content. An adhesive containing the resorcin/formaldehyde resin as an active ingredient manifests easy handling, and vaporization of resorcin is suppressed in a heat processing operation in adhering.

### EXAMPLES

The present invention will be illustrated further in detail based on examples below, but it is needless to say that the present invention is not limited to the examples.

The viscosity was measured at about 24° C. according to JIS Z8803-8 using a Type B viscometer.

### Reference Example

### Reaction of 1st Batch

[A] Process

377 g of calcium chloride and 521 g of water were charged in a reaction vessel, and stirred while cooling. Into the resulting solution was added 121 g of resorcin and 31 g of 3.6% hydrochloric acid, and the mixture was heated up to 72° C. and maintained for about 30 minutes. Next, the inner temperature was cooled down to about 60° C., then, preliminary polymerization was initiated at the same temperature so that mixed liquid of 53.6 g of a 37% formalin aqueous solution (methanol content: 2.5%) and 67 g of water could all be dropped over a period of 3 hours.

[B] process

From 1 hour of dropping of the formalin aqueous solution, 110 g of methyl ethyl ketone was dropped concurrently, and main polymerization was performed. Dropping of the formalin aqueous solution and dropping of methyl ethyl ketone were completed approximately at the same instant, then, the mixture was thermally insulated for about 10 minutes at the same temperature.

After completion of thermal insulation, stirring in the reaction vessel was immediately stopped, and the mixture was allowed to stand still for about 30 minutes, then, separated between an organic phase and an aqueous phase. The recovered aqueous phase contained 0.7% of methyl ethyl ketone and 0.2% of methyl alcohol.

The organic phase obtained above was charged in a distillation apparatus, and 400 g of hot water of about 60° C. was added to this, then, the solution in the apparatus was azeotropically distilled with stirring under conditions of 94° C./80 kPa. During azeotropic distillation, the distilled methyl ethyl ketone/water mixture was removed out of the system while cooling by a cooling tube.

The azeotropic distillation was stopped when the amount of the aqueous solution in the apparatus reached about 250 g, and the solution was cooled down to about 55° C.

To the residual liquid after distillation off of the methyl ethyl ketone/water mixture, 28 g of 25% ammonia water was added to render pH alkaline. Subsequently, the mixture was stirred for about 1 hour at about 55° C., and diluted with 30 g of water to obtain about 280 g of a resorcin/formaldehyde resin.

The composition of the resin was measured by GPC (gel permeation chromatography) to resultantly find that the resorcin content was 6.0%, the resorcin 2-core body content was 17%, the resorcin 3-core body concentration was 16%, the resorcin 4-core body concentration was 14%, the resorcin 5- or more-core body concentration was 48%, and the dry solid concentration by drying at 135° C. for 1 hour by a ventilation drier was 50%. The product was a resorcin/formaldehyde resin having a viscosity by a precise rotation viscometer of 533 (mPa·s), thus showing low viscosity and high flowability, and having low resorcin content.

### Example 1

1040 g of the aqueous phase recovered above (calcium chloride concentration: 36%) was charged in a vessel, and 1.8 g of calcium hydroxide was charged to adjust pH to 6.3, then, distillation was performed until the temperature in the vessel reached 103° C./53 kPa to distill off 149 g of the material, obtaining a salts-containing aqueous solution to be subjected to re-use. The composition of the salts-containing aqueous solution had a methyl ethyl ketone concentration of 0.1% or less, a methyl alcohol concentration of 0.1% or less and a calcium chloride concentration of 42.1%, and pH thereof was 5.9.

12 g of water and 2.5 g of anhydrous calcium chloride were added to and dissolved in the above-described salts-containing aqueous solution, then, 121 g of resorcin and 31 g of 3.6% hydrochloric acid were added, and the mixture was heated up to about 70° C. and maintained for about 30 minutes. Then, the inner temperature was cooled down to about 60° C., then, preliminary polymerization was initiated at the same temperature so that mixed liquid of 53.6 g of a 37% formalin aqueous solution (methanol content: 2.5%) and 67 g of water could all be dropped over a period of 3 hours. From 1 hour of dropping of the formalin aqueous solution, 110 g of methyl ethyl ketone was dropped concurrently, and main polymerization was performed. Dropping of the formalin aqueous solution and dropping of methyl ethyl ketone were completed approximately at the same instant, then, the mixture was thermally insulated for about 10 minutes at the same temperature.

After completion of thermal insulation, the mixture was maintained immediately at about 60° C. for about 30 minutes, then, stirring in the reaction vessel was stopped, and the mixture was allowed to stand still for about 30 minutes, then, separated between an organic phase and an aqueous phase. The recovered aqueous phase contained 0.7% of methyl ethyl ketone and 0.2% of methyl alcohol.

The organic phase obtained above was charged in a distillation apparatus, and 350 g of hot water of about 60° C. was added to this, then, the solution in the apparatus was azeotropically distilled with stirring under conditions of 98° C./91 kPa. During azeotropic distillation, the distilled methyl ethyl ketone/water mixture was removed out of the system while cooling by a cooling tube.

The azeotropic distillation was stopped when the amount of the aqueous solution reached about 230 g, and the solution was cooled down to about 55° C.

To the solution in the apparatus after distillation off of the methyl ethyl ketone/water mixture, 28 g of 25% ammonia water was added to render pH alkaline. Subsequently, the mixture was stirred for about 1 hour at about 55° C., and diluted with 47 g of water to obtain about 290 g of a resorcin/formaldehyde resin.

The composition of the resin was measured by GPC (gel permeation chromatography) to resultantly find that the resorcin concentration was 6.7%, the resorcin 2-core body concentration was 17%, the resorcin 3-core body concentration was 15%, the resorcin 4-core body concentration was 14%, the resorcin 5- or more-core body concentration was 48%, and the dry solid content by drying at 135° C. for 1 hour by a ventilation drier was 50%. The product was a resorcin/formaldehyde resin having a viscosity by a precise rotation viscometer of 553 (mPa·s), thus showing low viscosity and high flowability, and having low resorcin content.

### Example 2

The same procedure as in Example 1 was carried out excepting use of 1037 g of the aqueous phase recovered in Example 1 (calcium chloride concentration: 36%) instead of the aqueous phase recovered in Reference Example. The salts-containing aqueous solution had a methyl ethyl ketone concentration of 0.1% or less, a methyl alcohol concentration of 0.1% or less and a calcium chloride concentration of 42.2%, and pH of the solution was 5.8.

The amount of the resultant resorcin/formaldehyde resin was about 290 g, and the composition of the resin was measured by GPC (gel permeation chromatography) to resultantly find that the resorcin concentration was 7.0%, the resorcin 2-core body concentration was 16%, the resorcin 3-core body concentration was 14%, the resorcin 4-core body concentration was 13%, the resorcin 5- or more-core body concentration was 49%, and the dry solid content by drying at 135° C. for 1 hour by a ventilation drier was 50%. The product was a resorcin/formaldehyde resin having a viscosity by a precise rotation viscometer of 547 (mPa·s), thus showing low viscosity and high flowability, and having low resorcin content.

### Comparative Example 1

The same procedure as in Example 1 was carried out excepting use of the aqueous phase itself recovered in Reference Example instead of the salts-containing aqueous solution obtained in Example 1.

The amount of the resultant resorcin/formaldehyde resin was about 290 g, and the composition of the resin was measured by GPC (gel permeation chromatography) to resultantly find that the resorcin concentration was 3.0%, the resorcin 2-core body concentration was 11%, the resorcin 3-core body concentration was 8%, the resorcin 4-core body concentration was 10%, the resorcin 5- or more-core body concentration was 67%, and the dry solid content by drying at 135° C. for 1 hour by a ventilation drier was 50%. The product was a resorcin/formaldehyde resin having a viscosity by a precise rotation viscometer of 10000 or more (mPa·s), thus showing high viscosity and low flowability.

### Example 3

521 g of water and 377 g of calcium chloride were charged in a glass reaction vessel, and stirred while cooling. Into the resulting solution was added 121 g of resorcin and 31 g of 3.6% hydrochloric acid, and the mixture was heated up to 71° C. to prepare uniform mixed liquid. Next, the temperature of the reaction solution was cooled down to about 60° C., then, a dilute solution of 54 g of a 37% formaldehyde aqueous solution and 67 g of water was dropped at approximately constant speed over a period of 3 hours.

Two hours after initiation of dropping of the above-described formalin aqueous solution, 110 g of methyl ethyl ketone was dropped over a period of 1 hour. The procedure before initiation of dropping of methyl ethyl ketone was the preliminarily polymerization of the present invention. Dropping of the formaldehyde aqueous solution and dropping of methyl ethyl ketone were completed approximately at the same instant, then, the mixture was thermally insulated for about 10 minutes at the same temperature.

After completion of thermal insulation, 1.5 g of calcium hydroxide was added and the mixture was maintained at about 60° C. for 30 minutes. Stirring in the reaction vessel was stopped, and liquid separating was performed to obtain an organic phase.

The organic phase obtained above was charged in a distillation apparatus, and 300 g of water of about 50° C. was added to this, then, the organic phase was azeotropically distilled under from normal pressure to a reduced pressure of 80 kPa while regulating at 95° C. Azeotropic distillation was stopped when the amount of the reaction solution reached about 380 g, and the solution was cooled down to about 55° C.

To the resultant mass was added 100 g of water of about 50° C. and 18 g of 25% ammonia water and the mixture was stirred at about 55° C. for about 1 hour, then, the reaction solution was re-concentrated under from normal pressure to a reduced pressure of 53 kPa while adjusting to 85° C., thereby removing about 100 g of distilled components, then, the solution was cooled down to about 60° C.

To the cooled solution was added 11 g of 25% ammonia water and the mixture was stirred at about 60° C. for about 1 hour, to obtain about 290 g of a resorcin/formaldehyde resin.

The composition of the resin was measured by GPC (gel permeation chromatography, represented by area percentage of peaks excepting solvent. Solvent: tetrahydrofuran, flow rate: 1 ml/min, column temperature: 40° C., column: ShoudexKF-802 and Shoudex KF-802.5, two columns were used) to find that the resorcin content was 9.2%, the resorcin 2-core body content was 19%, the resorcin 3-core body concentration was 17%, the resorcin 4-core body concentration was 14%, the resorcin 5- or more-core body concentration was 40%, and the dry solid concentration by drying at 135° C. for 1 hour by a ventilation drier was 46%. The viscosity thereof was 66 (mPa·s).

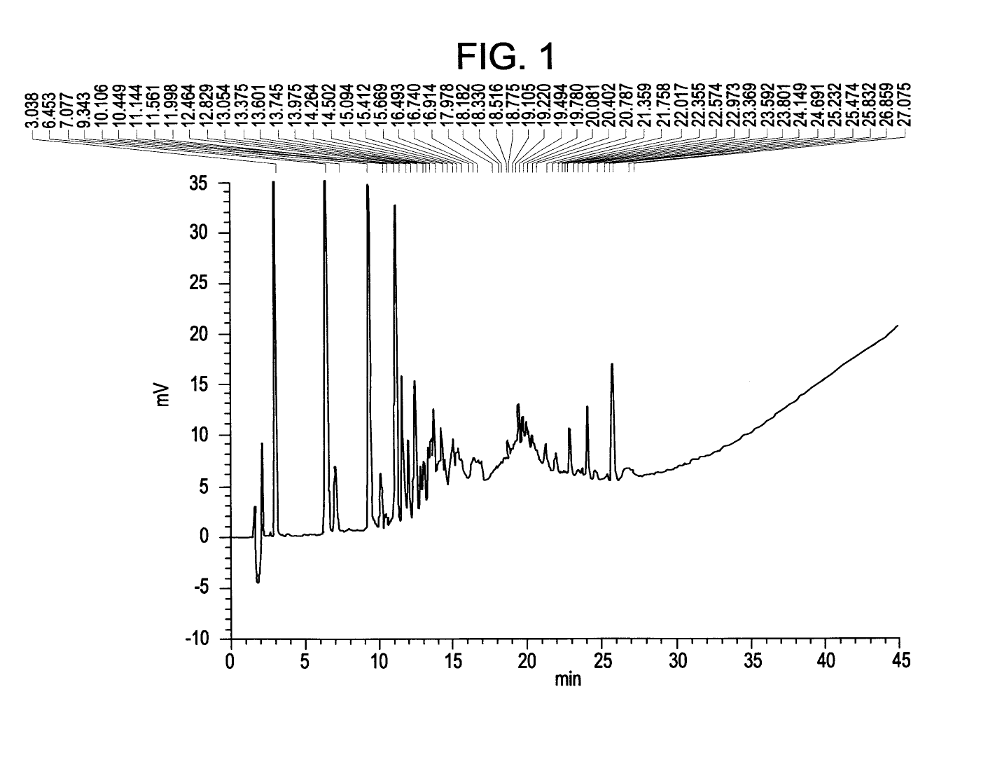

The above-described resin was analyzed by liquid chromatography, to obtain results shown in FIG. 1. The conditions of liquid chromatography are shown below.

Apparatus: LC10AT type, manufactured by Shimadzu Corp.

Column: Cadenza CD-C18 (4.6 mmφ×150 mm, filler spherical diameter 3 μm, manufactured by Imtakt)

Column constant-temperature bath temperature: 40° C.

Mobile phase: Solvent A (0.1% (V/V) trifluoroacetic acid aqueous solution)
Solvent B (0.1% (V/V) trifluoroacetic acid-containing acetonitrile)

Mobile phase flow rate: 1 ml per minute (wherein, solvent ratio A/B is 0.8 ml/0.2 ml, and concentration gradient is applied so that 1 ml of solvent A flows after 40 minutes)

Sample injection amount: 10 μl

Sample concentration: 4 mg/ml (solvent: methanol)

Ultraviolet detector: wavelength 254 nm

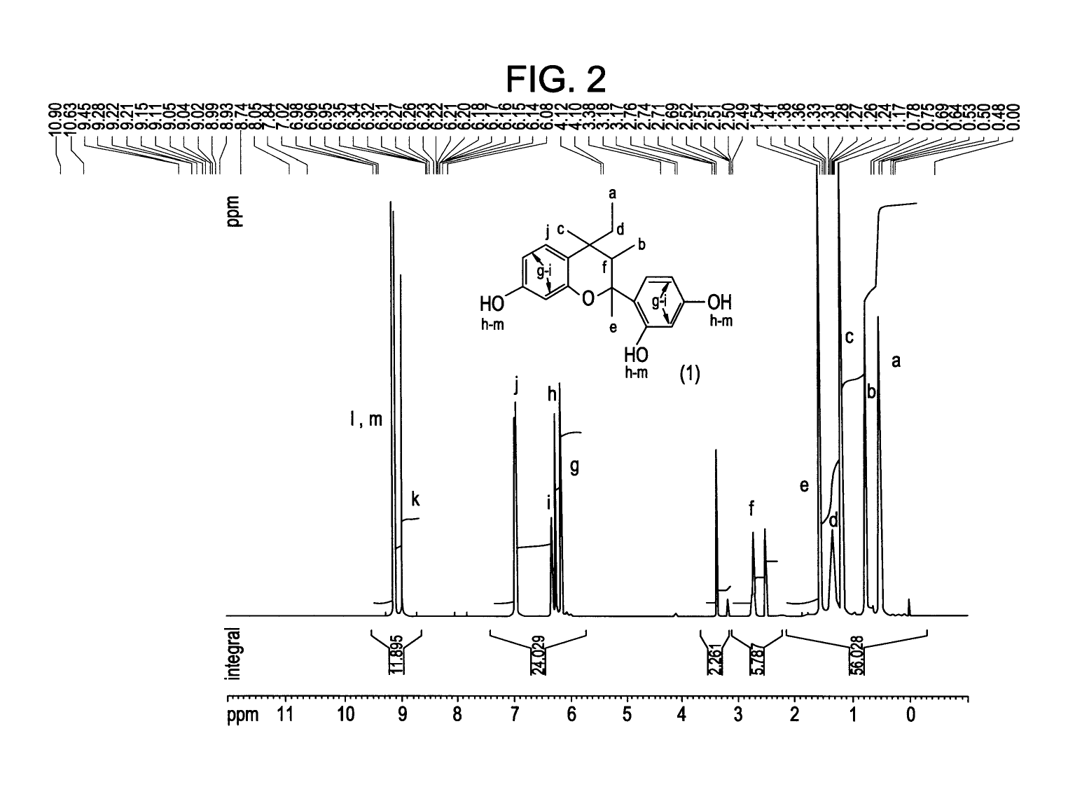

Components at elution times of 20.1 minutes and 25.8 minutes in FIG. 1 were batched off with column, respectively. The component of an elution time of 20.1 minutes was identified as a compound of the above-described formula (1) from the result of its ¹H-NMR (see FIG. 2, measuring solvent is heavy dimethyl sulfoxide).

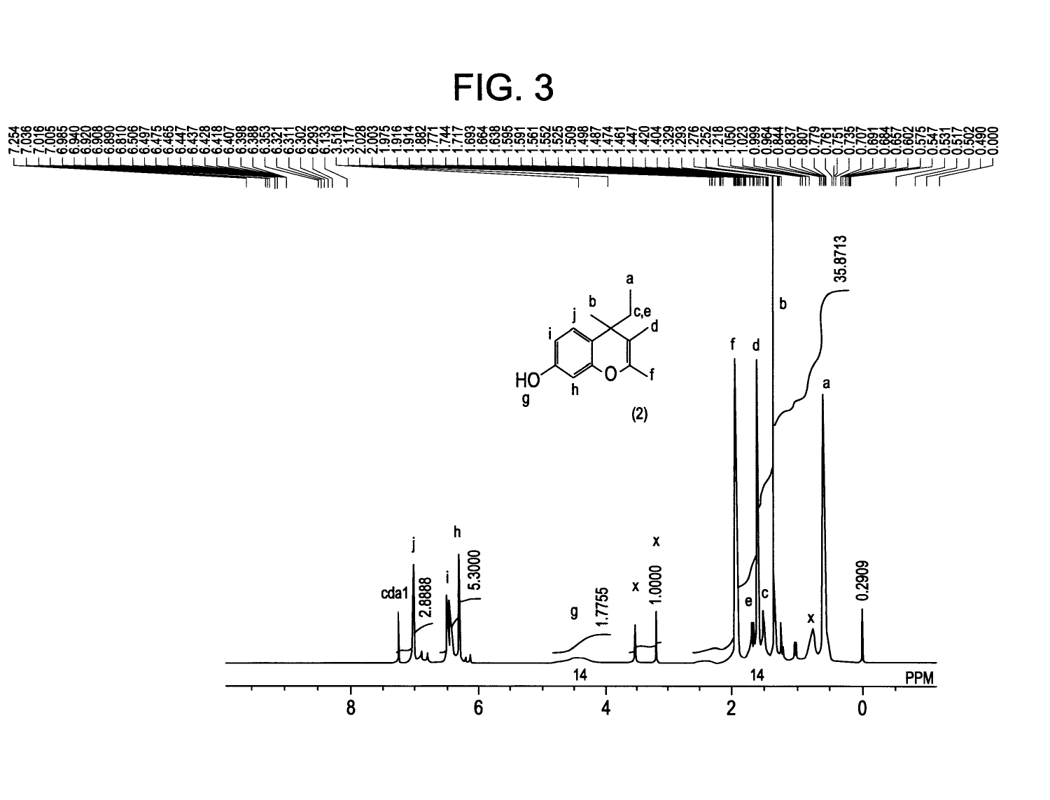

The component of an elution time of 25.8 minutes was identified as a compound of the above-described formula (2) from the result of its ¹H-NMR (see FIG. 3, measuring solvent is heavy chloroform).

The components at elution times of 19.8 minutes and 19.5 minutes in FIG. 1 had molecular weights of 450 and 572, respectively, from the results of LC-MS and identified as compounds of the above-described formulae (3) and (4).

Further, the components at elution times of 24.1 minutes and 23.0 minutes in FIG. 1 had molecular weights of 340 and 462, respectively, from the results of LC-MS and identified as compounds of the above-described formulae (5) and (6).

### Example 4

Mixed liquid prepared in the same manner as in Example 3 was cooled down to about 50° C., then, a dilute solution of 52 g of a 37% formaldehyde aqueous solution and 67 g of water was dropped approximately at constant speed over a period of 5 hours at the same temperature.

2.5 hours after initiation of dropping of the above-described formaldehyde aqueous solution, 110 g of methyl ethyl ketone was dropped over a period of 2.5 hours. The procedure before initiation of dropping of methyl ethyl ketone was the preliminarily polymerization of the present invention. Dropping of the formaldehyde aqueous solution and dropping of methyl ethyl ketone were completed approximately at the same instant. Subsequently, the mixture was thermally insulated for 1 hour at the same temperature.

After completion of thermal insulation, 1.5 g of calcium hydroxide was added and the mixture was maintained at about 50° C. for 30 minutes. Subsequently, the mixture was allowed to stand still at about 50° C., then, liquid separating was performed to obtain an organic phase.

Subsequently, the same azeotropic distillation as in Example 3 was performed. Azeotropic distillation was stopped when the amount of the reaction solution reached about 240 g, and 40 g of 25% ammonia water was added and the mixture was stirred at about 60° C. for about 1 hour, then, 19 g of water was added to obtain about 280 g of a resorcin/formaldehyde resin.

The composition of the resin was measured by GPC under the same conditions as in Example 3 to resultantly find that the resorcin concentration was 8.5%, the resorcin 2-core body concentration was 21%, the resorcin 3-core body concentration was 17%, the resorcin 4-core body concentration was 15%, the resorcin 5- or more-core body concentration was 39%, and the dry solid content by drying at 135° C. for 1 hour by a ventilation drier was 50%. The viscosity thereof was 142 (mPa·s).

### Comparative Example 2

Mixed liquid was prepared in the same manner as in Example 3, then, the same procedure as in Example 3 was carried out excepting that a dilute solution of 54 g of 37% formaldehyde aqueous solution and 67 g of water, and 110 g of methyl ethyl ketone were simultaneously dropped approximately at constant speed over a period of 3 hours. About 310 g of a resorcin/formaldehyde/methyl ethyl ketone resin was obtained and the resorcin concentration was 3.8%, the resorcin 2-core body concentration was 17%, the resorcin 3-core body concentration was 14%, the resorcin 4-core body concentration was 13%, the resorcin 5- or more-core body concentration was 52%, and the dry solid content by drying at 135° C. for 1 hour by a ventilation drier was 48%. The viscosity thereof was 5630 (mPa·s).

### Comparative Example 3

Mixed liquid was prepared in the same manner as in Example 4, then, the same procedure as in Example 4 was carried out excepting that a dilute solution of 52 g of 37% formaldehyde aqueous solution and 67 g of water, and 110 g of methyl ethyl ketone were dropped approximately at constant speed over a period of 5 hours. About 290 g of a resorcin/formaldehyde/methyl ethyl ketone resin was obtained and the resorcin concentration was 44%, the resorcin 2-core body concentration was 18%, the resorcin 3-core body concentration was 16%, the resorcin 4-core body concentration was 14%, the resorcin 5- or more-core body concentration was 47%, and the dry solid content by drying at 135° C. for 1 hour by a ventilation drier was 50%. The viscosity thereof was 2550 (mPa·s).

### Comparative Example 4

266 g of water, 266 g of calcium chloride and 74 g of resorcin were charged in a glass reaction vessel, and heated up to 50° C. Thereafter, 0.9 g of 36% hydrochloric acid and 30 g of methyl ethyl ketone were added and the temperature thereof was maintained at 50° C. Into this mixed liquid, 33 g of a 37% formaldehyde aqueous solution was dropped over a period of 30 minutes. Subsequently, the mixture was thermally insulated at the same temperature for 1 hour. In the content, a gummy resin adhered to a stirring rod, showing remarkably poor physical properties.

The mass after completion of the above-described thermal insulation was allowed to stand still for 20 minutes, and the aqueous phase was removed. 200 g of methyl ethyl ketone and 100 g of water were charged into the content remaining after removal of the aqueous phase, and the mixture was thermally insulated at 50° C. for 30 minutes. Thereafter, the mixture was allowed to stand still for 30 minutes, then, the aqueous phase was removed. The resulting organic phase was charged in a distillation apparatus, 400 g of methyl ethyl ketone was added to this, then, the reaction solution was concentrated under from normal pressure to a reduced pressure of 27 kPa while regulating at 50° C. Concentration was continued until the amount of the reaction solution reached about 180 g.

To the resultant mass was added 200 g of water of about 50° C. and the reaction solution was re-concentrated under from normal pressure to a reduced pressure of 27 kPa while adjusting to 67° C. When the amount of the reaction solution reached about 160 g, the solution was concentrated.

Thereafter, the solution was cooled down to room temperature to obtain about 160 g of a resorcin/formaldehyde resin.

The composition of the resin was measured by GPC (gel permeation chromatography) in the same manner as in Example 3 to resultantly find that the resorcin concentration was 5.8%, the resorcin 2-core body concentration was 17%, the resorcin 3-core body concentration was 14%, the resorcin 4-core body concentration was 13%, the resorcin 5- or more-core body concentration was 51%, and the dry solid content by drying at 135° C. for 1 hour by a ventilation drier was 49%. The viscosity thereof was 1970 (mPa·s).

### INDUSTRIAL APPLICABILITY

According to the present invention, a salts-containing aqueous solution can be re-used repeatedly, and cost for a draining treatment can also be deleted, and a resorcin/formaldehyde resin having low viscosity, excellent flowability and low resorcin content can be obtained.

The resultant resorcin/formaldehyde resin has a viscosity of usually 1000 mPa·s or less, preferably 500 mPa·s or less and a resorcin content of 10% or less, thus, its flowability is excellent, and resorcin scarcely vaporizes in a thermal processing operation, that is, this resin can be used suitably as an adhesive for woods and tires.

What is claimed is:

1. A method for producing a resorcin/formaldehyde resin comprising subjecting a salts-containing aqueous solution, resorcin, formaldehydes and aliphatic ketone having 3 to 6 carbon atoms to a polymerization reaction in the presence of an acidic catalyst, separating the reaction liquid after reaction between an aqueous phase and an organic phase, and obtaining a resorcin/formaldehyde resin from the organic phase, wherein the aqueous phase recovered by separating is distilled to adjust the aliphatic ketone content to 0.3 wt % or less and the alcohol content to 0.1 wt % or less, and the aqueous phase having a salts concentration adjusted to 35 to 45 wt % is used as said salts-containing aqueous solution.

2. The production method according to claim 1, wherein the polymerization reaction includes the following processes [A] and [B]:
[A] a process of adding formaldehydes to mixed liquid containing a salts-containing aqueous solution, resorcin and acidic catalyst and preliminarily polymerizing them to obtain a preliminarily polymerized liquid;
[B] a process of adding an aliphatic ketone having 3 to 6 carbon atoms and formaldehydes to the preliminarily polymerized liquid obtained in the process [A] and main-polymerizing them to obtain polymerized liquid.

3. A method for producing a resorcin/formaldehyde resin comprising adding formaldehydes to mixed liquid containing a salts-containing aqueous solution, resorcin and acidic catalyst and preliminarily polymerizing them to obtain a preliminarily polymerized liquid, adding an aliphatic ketone having 3 to 6 carbon atoms and formaldehydes to the resultant preliminarily polymerized liquid and main-polymerizing them to obtain polymerized liquid.

4. The production method according to claim 2 wherein the amount of the formaldehydes to be used for the preliminarily polymerization is 0.01 to 0.7 mol per mol of resorcin, and the total amount of the formaldehydes is 0.3 to 1 mol per mol of resorcin.

5. The production method according to claim 1 wherein the salt is calcium chloride.

6. The production method according to claim 2 wherein the reaction time of the preliminarily polymerization is 10 minutes to 2 hours.

7. The production method according to claim 2 wherein the aliphatic ketone and formaldehydes are mixed intermittently or continuously with the preliminarily polymerized liquid over a period of 1 to 5 hours.

8. The production method according to claim 2 wherein the aliphatic ketone is mixed with the preliminarily polymerized liquid over a period of 30 minutes, and the aliphatic ketone is mixed before completion of mixing of all the formaldehydes.

9. The production method according to claim 2 wherein the amount of the aliphatic ketone to be mixed with the preliminarily polymerized liquid is 0.8 to 6 mol per mol of the total amount of the formaldehydes.

10. The production method according to claim 2 wherein the polymerized liquid after completion of the main polymerization is neutralized, separated, and the resulting organic phase is azeotropically dehydrated, then, ammonia is mixed with this.
